(19) United States
(12) Patent Application Publication
(10) Pub. No.: US 2008/0181837 A1
(43) Pub. Date: Jul. 31, 2008

(54) Hydrogen, Carbon Monoxide, and N2 Recovery From Low BTU Gases

(76) Inventors: Bhadra S. GROVER, Sugar Land, TX (US); Dennis A. Vauk, Houston, TX (US)

Correspondence Address: AIR LIQUIDE;Intellectual Property, 2700 POST OAK BOULEVARD, SUITE 1800, HOUSTON, TX, 77056, US

(21) Appl. No.: 11/960,009

(22) Filed: Dec. 19, 2007

Related U.S. Application Data
(60) Provisional application No. 60/886,999, filed on Jan. 29, 2007.

(51) Int. Cl. C01B 21/04

(52) U.S. Cl. 423/351

(57) ABSTRACT

A process for recovering hydrogen from a multi-component gas stream is provided. This process includes compressing said multi-component gas stream, thereby creating a compressed multi-component gas stream. This process includes heating the compressed multi-component gas stream, thereby creating a heated compressed multi-component gas stream. This process also includes introducing steam into the heated compressed multi-component gas stream, thereby creating a first feed stream. This process further includes introducing the first feed stream into a CO shift conversion process, thereby creating a first intermediate stream. This process also includes introducing the first intermediate stream into an amine wash process, thereby creating a second intermediate stream and a carbon dioxide stream. This process also includes introducing the second intermediate stream into a methanation process, thereby creating a third intermediate stream. This process also includes introducing the third intermediate stream into an adsorbent bed to remove moisture, thereby creating a fourth intermediate dry stream. This process also includes introducing the fourth intermediate stream into a cryogenic distillation process, thereby creating a hydrogen stream, a nitrogen stream, and a waste stream.

### CROSS REFERENCE TO RELATED APPLICATIONS

This application claims the benefit of U.S. Provisional Application No. 60/886,999, filed Jan. 29, 2007, the entire contents of which are incorporated herein by reference.

### BACKGROUND

Some processes such as the Flexicoker process produce a low BTU gas that has 40% to 60% inert gases such as nitrogen and carbon dioxide. This gas typically also contains desirable gases such as hydrogen and carbon monoxide. However, the recovery of hydrogen and carbon monoxide from such gases has not been found to be economical. Often, this low BTU gas has been used as fuel in heaters and boilers. The presence of such high levels of inert gases makes the resulting combustion of this gas very inefficient, as a large percentage of the resulting heat is lost as waste heat in the flue gas that exits via the stack. The presence of such a high concentration of nitrogen also tends to create oxides of nitrogen (NOx) which is environmentally harmful.

There are no known solutions for separating the desirable gases from the undesirable gases in such a stream, which are economically viable. Obvious solutions are to use either membrane technology or pressure swing absorber technology. However, since the source of the low BTU gas is usually at a low pressure, it would typically have to be compressed to between about 20 bar and 60 bar to be processed through either a PSA or a typical membrane-type separator. This compression brings with it a high compression power cost, which makes such a solution unattractive. Ordinary PSA and membrane technologies are also only capable of recovering hydrogen. And, typically the hydrogen recovery will be rather small and the size of the units will need to be rather large to handle such a large volume of inert gases. Consequently, it is not possible to effectively separate nitrogen, carbon monoxide, and methane in these processes.

Hence, there is a general need in society for a method and system for economically separating hydrogen, nitrogen, carbon monoxide, and methane from such low BTU gases. The present solution uses cryogenic fractionation to perform such separation, typically at a pressure of about 4 bar to about 8 bar. The preconditioning of the feed is another feature of the present solution.

### SUMMARY

In one aspect of the present invention, a process for recovering hydrogen from a multi-component gas stream is provided. This process includes compressing said multi-component gas stream, thereby creating a compressed multi-component gas stream. This process also includes introducing said first feed stream into an amine wash process for carbon dioxide removal, thereby creating an first intermediate stream and a carbon dioxide stream. This process also includes introducing said first intermediate stream into an adsorbent bed to remove moisture, thereby creating a second intermediate dry stream. This process also includes introducing said second intermediate dry stream into a cryogenic distillation process, thereby creating a hydrogen stream, a nitrogen stream, a carbon monoxide stream, and a waste stream.

In another embodiment of the present invention, a process for recovering hydrogen from a multi-component gas stream is provided. This process includes compressing said multi-component gas stream, thereby creating a compressed multi-component gas stream. This process includes heating said compressed multi-component gas stream, thereby creating a heated compressed multi-component gas stream. This process also includes introducing stream into said heated compressed multi-component gas stream, thereby creating a first feed stream. This process further includes introducing said first feed stream into a carbon monoxide shift conversion process, thereby creating a first intermediate stream. This process also includes introducing said first intermediate stream into an amine wash process, thereby creating a second intermediate stream and a carbon dioxide stream. This process also includes introducing said second intermediate stream into a methanation process, thereby creating a third intermediate stream. This process also includes introducing said third intermediate stream into an adsorbent bed to remove moisture, thereby creating a fourth intermediate dry stream. This process also includes introducing said fourth intermediate stream into a cryogenic distillation process, thereby creating a hydrogen stream, a nitrogen stream, and a waste stream.

### DESCRIPTION OF DRAWINGS

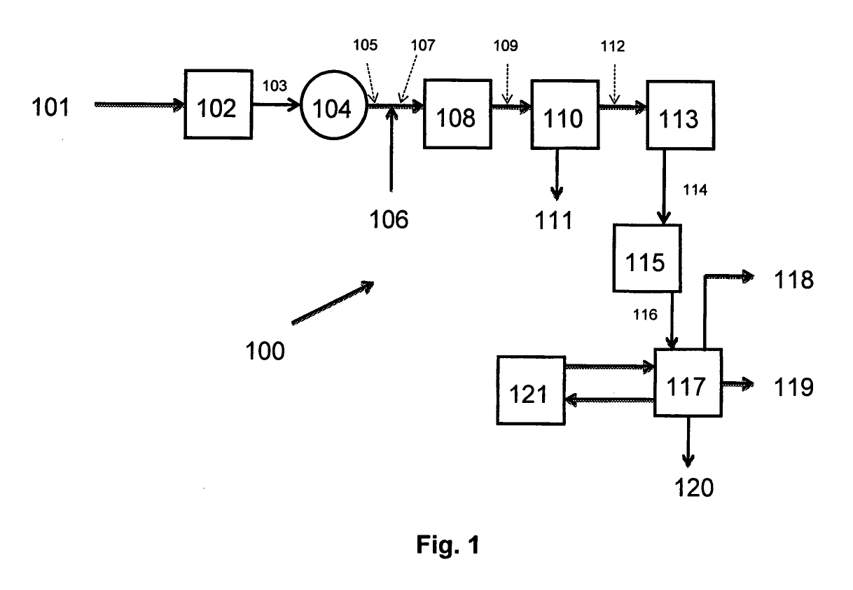

The sole FIGURE (FIG. 1) is a schematic representation of one embodiment of the present invention.

### DETAILED DESCRIPTION

Illustrative embodiments of the invention are described below. While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

This invention applies to the recovery of hydrogen, carbon monoxide, or a combination of the two, from a low BTU fuel such as the coke gas product of a flexicoker. Off-gases such as this typically contain between 40% and 60% inert gases such as nitrogen or carbon dioxide. The removal of these inert gases by conventional methods is not economical. If this low BTU gas is burned in utility boilers or heaters, the thermal efficiency of the system suffers due to the heating and subsequent discarding of these inert gases.

One embodiment of the present invention, system 100, is described in the sole FIGURE (FIG. 1). In this particular case the desired products are hydrogen, nitrogen, and carbon dioxide. The off-gas containing these desired products is multi-component gas stream 101. Stream 101 is typically at a low pressure such as about 15 psig. Low pressure stream 101 is compressed in compression means 102 to a pressure of approximately 20 psig to 1500 psig, preferably between about 50 psig to 100 psig, thereby resulting in compressed multi-gas stream 103. Compression means 102 may be any such means known to the skilled artisan. Compressed multi-gas stream 103 now may be heated, thereby resulting in heated compressed multi-component gas stream 105. Steam 106 is combined with heated compressed multi-component gas stream 105, resulting in a first feed stream 107.

First feed stream 107 is then introduced into a CO shift conversion reactor 108, thereby resulting in first intermediate stream 109. Within CO shift conversion reactor 108 the carbon monoxide that is present is shifted to hydrogen and carbon dioxide. This shift may be done in a single stage, or in multiple stages in order to optimize the conversion process itself and the size of the reactor. Said first intermediate stream 109 is then introduced into amine wash system 110, wherein any carbon dioxide is washed off, thereby resulting in second intermediate stream 112 and carbon dioxide stream 111. Said second intermediate stream 112 is then introduced into methanator 113, wherein any residual carbon monoxide and carbon dioxide is eliminated, thereby resulting in third intermediate stream 114. Third intermediate stream 114 is then introduced into adsorbent bed 115, wherein any moisture that may be present is removed. This results in fourth intermediate dry stream 116. Fourth intermediate dry stream 116, which consists primarily of hydrogen, nitrogen and methane, is then introduced into a cryogenic distillation column 117. This can be any cryogenic distillation column design known to the skilled artisan. This results in the separation of hydrogen stream 118, nitrogen stream 119, and waste stream 120. Waste stream 120 consists primarily of methane with some hydrogen and nitrogen present. Should additional refrigeration be required by cryogenic distillation column 117, it may be provided by external refrigeration source 121.

In another embodiment, if carbon monoxide is a desired product, then CO Shift conversion reactor 108 and methanator 113 may be eliminated. This will required the design of cryogenic distillation column 117 to be modified to account for the carbon monoxide as a product.

In another embodiment, the heat that is generated by CO shift conversion reactor 108 may be used to generate steam 106, thereby reducing the amount of stream that must be imported into the cycle. In another embodiment additional purification steps may be required to remove H2S that may be present upstream of CO Shift conversion reactor 108.

1. A process for recovering hydrogen from a multi-component gas stream comprising;
compressing said multi-component gas stream, thereby creating a compressed multi-component gas stream;
introducing said compressed multi-component gas stream into an amine wash process for CO2 removal, thereby creating an first intermediate stream and a carbon dioxide stream;
introducing said first intermediate stream into an adsorbent bed to remove moisture, thereby creating a second intermediate dry stream;
introducing said second intermediate dry stream into a cryogenic distillation process, thereby creating a hydrogen stream, a nitrogen stream, a carbon monoxide stream, and a waste stream.

2. The process of claim 1, wherein said compressed multi-component gas stream has a pressure of between about 50 psig and about 100 psig.

3. The process of claim 1, wherein said compressed multi-component gas steam has a pressure of between about 20 psig and about 1500 psig.

4. The process of claim 1, wherein said CO2 removal is done by other known solvents.

5. The process of claim 1, wherein said waste stream comprises at least one component selected from the group consisting of hydrocarbons, hydrogen, carbon monoxide, and nitrogen.

6. The process of claim 5, wherein said hydrocarbons are selected from the group consisting of methane and ethane.

7. The process of claim 1, further comprising a purification step prior to said compression, wherein hydrogen sulfide is removed from said multi-component gas stream.

8. The process of claim 1, wherein said cryogenic distillation process obtains at least part of the required refrigeration from an external source, with the balance of said refrigeration coming from the expansion of said waste stream.

9. A process for recovering hydrogen from a multi-component gas stream comprising;
a compressing said multi-component gas stream, thereby creating a compressed multi-component gas stream;
heating said compressed multi-component gas stream, thereby creating a heated compressed multi-component gas stream;
introducing steam into said heated compressed multi-component gas stream, thereby creating a first feed stream;
introducing said first feed stream into a CO shift conversion process, thereby creating a first intermediate stream;
introducing said first intermediate stream into an amine wash process, thereby creating a second intermediate stream and a carbon dioxide stream;
introducing said second intermediate stream into a methanation process, thereby creating a third intermediate stream;
introducing said third intermediate stream into an adsorbent bed to remove moisture, thereby creating a fourth intermediate dry stream; and
introducing said fourth intermediate stream into a cryogenic distillation process, thereby creating a hydrogen stream, a nitrogen stream, and a waste stream.

10. The process of claim 9, wherein said compressed multi-component gas stream has a pressure of between about 50 psig and about 100 psig.

11. The process of claim 9, wherein said compressed multi-component gas steam has a pressure of between about 20 psig and about 1500 psig

12. The process of claim 9, wherein said waste stream comprises at least one component from the group consisting of methane, hydrogen and nitrogen.

13. The process of claim 9, wherein said CO shift conversion process generates useful heat, and wherein said heat is used to generate at least a portion of said steam.

14. The process of claim 9, wherein said CO shift conversion is done in multiple stages with intermediate heat recovery.

15. The process of claim 9, wherein said CO shift conversion is performed in two stages with intermediate heat recovery.

16. The process of claim 9, further comprising a purification step prior to said compression, wherein hydrogen sulfide is removed from said multi-component gas stream.

17. The process of claim 9, wherein said cryogenic distillation process obtains at least part of the required refrigeration from an external source, with the balance of said refrigeration coming from the expansion of said waste stream.
